(19) United States
(12) Patent Application Publication
(10) Pub. No.: US 2017/0039636 A1
(43) Pub. Date: Feb. 9, 2017

(54) PROCURING SPATIALLY FEASIBLE ON-DEMAND HOUSEHOLD-RELATED GOODS OR SERVICES

(71) Applicant: GetBid, Inc., Irvine, CA (US)

(72) Inventor: Manuchehr Khoshbin, Newport Coast, CA (US)

(73) Assignee: GetBid, Inc., Irvine, CA (US)

(21) Appl. No.: 14/821,084

(22) Filed: Aug. 7, 2015

(51) Int. Cl. G06Q 30/08; G06Q 30/06; H04W 4/02

(52) U.S. Cl. CPC G06Q 30/08; H04W 4/02; G06Q 30/0639

(57) ABSTRACT

Methods of procuring urgent household-related goods or services enable consumers to obtain goods or services from local vendors offering those goods or services within a predetermined region. These methods may be implemented on devices such as smart phones, desktop computers, and servers. A server computes distances between the consumer device and preapproved vendors' locations, selects, and notifies a number of local vendors of the request. Upon receiving a number of vendor acceptances, the server selects a local vendor, notifies the consumer and the selected local vendor, and presents them with corresponding summaries. Methods of reverse auctioning of household-related goods or services enable consumers to receive and accept the lowest bid from vendors offering those goods or services within a predetermined time interval.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to methods of procuring spatially feasible on-demand household-related goods or services, including computer programs, user interface, devices, and network systems. In particular, the methods, which may be implemented on smart phones, desktops, and/or computer network systems, allow consumers to obtain household-related goods or services from vendors capable of providing same within a predetermined region.

### BACKGROUND

Existing online services do not provide a platform where consumers and preapproved vendors are selected based on their locations. The present invention discloses methods and systems for procuring urgent household-related goods or services including reverse auctioning. These methods enable consumers to request and obtain goods or services from preapproved vendors within a predetermined region. Location of the consumer device and those of preapproved vendors are processed to determine the most spatially feasible preapproved local vendors offering the requested goods or services. Summaries of local vendors and consumers are provided so as to facilitate direct contact between consumers and local vendors.

### SUMMARY

In one aspect, a machine implemented method of procuring urgent household-related goods or services is disclosed, wherein the method comprises selecting one of a good and a service from a plurality of available goods and services, via a user device, transmitting a request for the one of a good and a service, via the user device, transmitting a user-device location of the user device, via the user device, receiving the request, via a server, receiving the location, via the server, selecting one or more preapproved vendors from a list of preapproved vendors offering the available goods and services, wherein the list of preapproved vendors and vendor locations of the preapproved vendors are stored on a storage device of the server, via the server, computing one or more distances between one or more vendor locations of the one or more preapproved vendors and the user-device location, via the server, selecting one or more local vendors from the one or more preapproved vendors whose distances are within a predetermined region, via the server, transmitting one or more vendor notices, via the server, receiving the one or more vendor notices, via one or more local vendor devices, transmitting one or more vendor acceptances, via the one or more local vendor devices, receiving the one or more vendor acceptances, via the server, selecting one of the one or more local vendors associated with one of the one or more vendor acceptances, via the server, transmitting a user notice, wherein the user notice comprises a local-vendor summary of the one of the one or more local vendors, via the server, transmitting a local-vendor notice, wherein the local-vendor notice comprises a user summary, via the server, receiving the user notice, via the user device, and receiving the local-vendor notice, via one of the one or more local vendor devices associated with the one of the one or more local vendors.

Preferably, the local-vendor summary comprises at least one of name of business, type of business, phone number of business, and address of business.

Preferably, the user summary comprises at least one of name of user, phone number of user, and address of user.

Preferably, the method further comprises transmitting one or more local-vendor rejection notice, via the server.

In another aspect, a machine implemented method of obtaining urgent household-related goods or services is disclosed, wherein the method comprises selecting one of a good and a service from a plurality of available goods and services, via a user device, transmitting a request for the one of a good and a service, via the user device, transmitting a user-device location of the user device, via the user device, and receiving a user notice, via the user device, wherein the user notice comprises local-vendor summary of a local vendor, wherein the local vendor is selected from one or more local vendors, wherein the one or more local vendors are selected from one or more preapproved vendors whose distances between their locations and user-device location are within a predetermined region, and wherein the one or more preapproved vendors are selected from a list of preapproved vendors offering the available goods and services.

Preferably, the predetermined region is a geographical area having the same postal zip code.

Preferably, the one of a good and a service from a plurality of available goods and services is one of a pizza, bottle of wine, a cigar, a handyman service, a plumbing service, a maid service, and a gardening service.

Preferably, a non-transitory machine-readable storage medium, which provides instructions that, when executed by a processing system, causes the processing system to perform operations according to the above method.

Preferably, a method provides a user interface for obtaining urgent household-related goods or services, the user interface being accessible via the user device, said method comprising the above method.

Preferably, a non-transitory machine-readable storage medium, which provides instructions that, when executed by a processing system, causes the processing system to perform operations according to the above method.

In another aspect, a computer network system for procuring urgent household-related goods or services is disclosed, wherein the system comprises a user device having a processing unit and program code stored on a storage device of said user device, said program code to perform a user method when executed by said processing unit, a server having a processing unit and program code stored on a storage device of said server, said program code to perform a server method when executed by said processing unit, and one or more local vendor devices, each local vendor device having a processing unit and program code stored on a storage device of said local vendor device, said program code to perform a local vendor method when executed by said processing unit, said user method, comprising selecting one of a good and a service from a plurality of available goods and services, transmitting a request for the one of a good and a service, transmitting a user-device location of the user device, and receiving a user notice, said server method, comprising, receiving the request, receiving the location, selecting one or more preapproved vendors from a list of preapproved vendors offering the available goods and services, wherein the list of preapproved vendors and vendor locations of the preapproved vendors are stored on the storage device of the server, computing one or more distances between one or more vendor locations of the one or more preapproved vendors and the user-device location, selecting one or more local vendors from the one or more preapproved vendors whose distances are within a predetermined region, transmitting one or more vendor notices, receiving one or more vendor acceptances, selecting one of the one or more local vendors associated with one of the one or more vendor acceptances, transmitting the user notice, wherein the user notice comprises a local-vendor summary of the one of the one or more local vendors, and transmitting a local-vendor notice, wherein the local-vendor notice comprises a user summary, said local vendor method, comprising receiving the one or more vendor notices, transmitting the one or more vendor acceptances, and receiving the local-vendor notice, via one of the one or more local vendor devices associated with the one of the one or more local vendors.

Preferably, the local-vendor summary comprises at least one of name of business, type of business, phone number of business, and address of business.

Preferably, the user summary comprises at least one of name of user, phone number of user, and address of user.

Preferably, the predetermined region is a geographical area having the same postal zip code.

Preferably, the one of a good and a service from a plurality of available goods and services is one of a pizza, bottle of wine, a cigar, a handyman service, a plumbing service, a maid service, and a gardening service.

In another aspect, a machine implemented method of reverse auctioning of household-related goods or services is disclosed, wherein the method comprises selecting a geographical region, via a user device, transmitting the geographical region, via the user device, selecting one of a good and a service from a plurality of available goods and services, via the user device, transmitting a request for the one of a good and a service, via the user device, transmitting a request-time, via the user device, receiving the geographical region, via a server, receiving the request, via the server, receiving the request-time, via the server, selecting a plurality of preapproved vendors from a list of preapproved vendors within the geographical region and offering the available goods and services, wherein the list of preapproved vendors are stored on a storage device of the server, via the server, transmitting a plurality of vendor notices, via the server, receiving the plurality of vendor notices, via a plurality of vendor devices, transmitting one or more vendor bids, via one or more of the plurality of vendor devices, receiving the one or more vendor bids, via the server, selecting one or more timely-vendor bids from the one or more vendor bids which are received within a predetermined time interval after the request-time, via the server, transmitting a lowest bid from the one or more timely-vendor bids, via the server, receiving the lowest bid, via the user device, accepting the lowest bid, via the user device, transmitting a user acceptance, via the user device, receiving the user acceptance, via the server, transmitting a user notice, wherein the user notice comprises a lowest-vendor summary, via the server, transmitting a lowest-vendor notice, wherein the lowest-vendor notice comprises a user summary, via the server, receiving the user notice, via the user device, and receiving the lowest-vendor notice, via one of the one or more of the plurality of vendor devices associated with the lowest bid.

Preferably, the predetermined time interval is three days.

Preferably, the one of a good and a service from a plurality of available goods and services is one of a pizza, bottle of wine, a cigar, a handyman service, a plumbing service, a maid service, and a gardening service.

Preferably, a non-transitory machine-readable storage medium, which provides instructions that, when executed by a processing system, causes the processing system to perform operations according to the above method.

Preferably, a method provides a user interface for obtaining urgent household-related goods or services, the user interface being accessible via the user device, the plurality of vendor devices, and the server, said method comprising the above method.

Preferably, a non-transitory machine-readable storage medium, which provides instructions that, when executed by a processing system, causes the processing system to perform operations according to the above method.

### BRIEF DESCRIPTION OF THE DRAWINGS

FIG. 1 is a diagram depicting one preferred embodiment of a computer network system, including devices and communication network, which may be utilized to implement the methods according to the present invention.

FIG. 2 shows one preferred method of providing a user interface for obtaining urgent household-related goods or services in accordance with the present invention.

FIG. 2A shows one preferred method of providing a local-vendor summary in accordance with the present invention.

FIG. 2B shows one preferred method of providing a user summary in accordance with the present invention.

FIG. 2C shows one preferred method of providing a vendor notice in accordance with the present invention.

FIG. 3 shows a flow diagram of one preferred method of procuring urgent household-related goods or services in accordance with the present invention.

FIG. 4 shows a flow diagram of one preferred method of reverse auctioning of household-related goods or services in accordance with the present invention.

### DETAILED DESCRIPTION OF THE PRESENTLY PREFERRED EMBODIMENTS

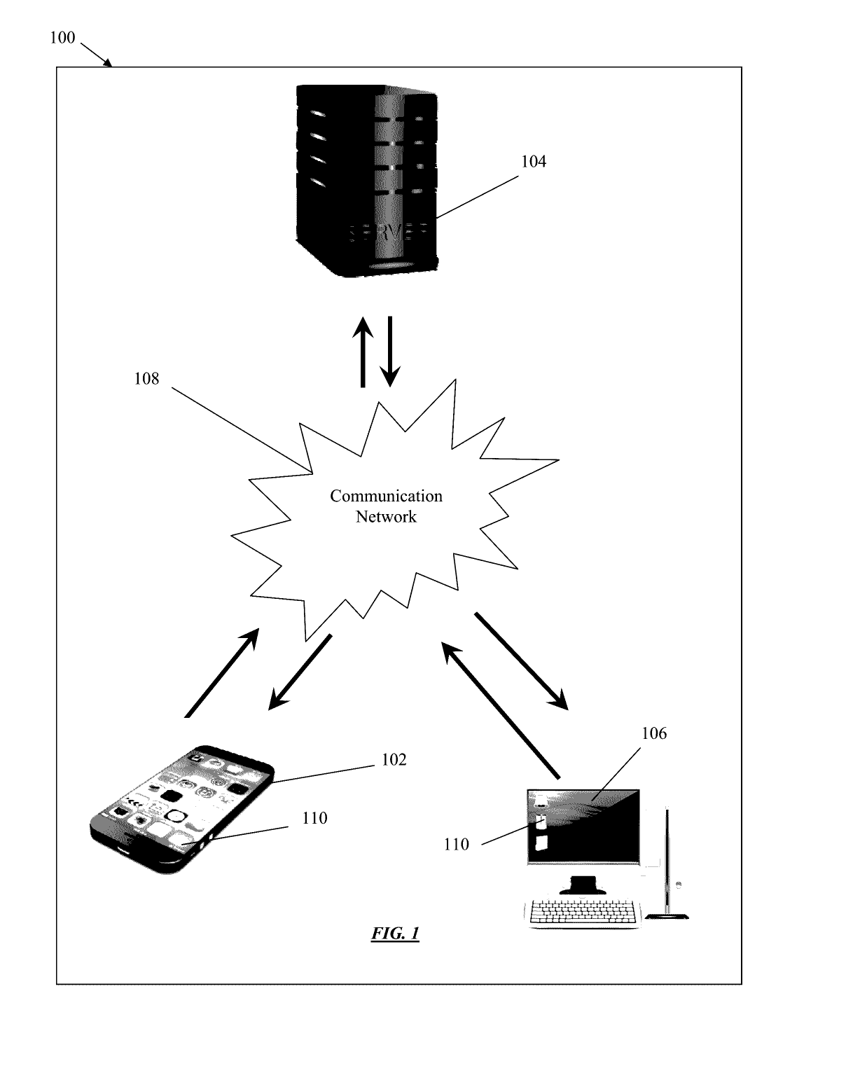

FIG. 1 depicts a diagram of one preferred embodiment of a computer network system for procuring urgent household-related goods or services 100, including devices 102, 104, and 106, and communication network 108, which may be utilized to implement the methods according to the present invention. In this preferred embodiment, the device 102 is a smart phone such as those discussed above or the Apple iPhone, the device 104 is a server such as those discussed above or the Hewlett-Packard Server, and the device 106 is a desktop, such as a Dell desktop computer. Execution of the present methods is not limited to iOS or DOS operating systems and other operating systems such as Android operating systems can be utilized. Execution of the methods discussed herein may be initiated by tapping on an icon 110, known to artisans of ordinary skill as an App. The devices 102, 104, and 106 communicate through the communication network 108. The communication network 108 can be a combination of wired and wireless networks and comprises at least one of the Internet, Wi-Fi, phone lines, ground-based communication devices and software, routers, cables, interface software, air-based communication devices, satellites, and satellite transceivers. Execution of the steps included in the several methods discussed herein may be divided and performed separately by the devices making up the computer network system for procuring urgent household-related goods or services 100. As known to artisans of ordinary skill, all the devices in the computer network system for procuring urgent household-related goods or services 100, including the devices 102, 104, and 106, have processing systems and program codes, stored on storage devices of these devices, which when executed, perform one or more of the several methods of the present invention.

The App 110 may be used to execute the steps of one or more of the several methods discussed herein. For instance, the user of the device 102, referred to as the consumer, taps on the App 110 and is presented with a user interface, discussed in more details below, to obtain an urgent household-related goods or services from a local vendor using the device 106 and the App 110. The user, using the device 102, uses the App 110 to select a good or service, for instance plumbing service, from a plurality of available goods and services. The App 110 transmits a request for the selected plumbing service and also transmits a location coordinates of the device 102, via the communication network 108.

Server systems using servers such as the server 104 having processing units and program codes manage the transmission and reception of communications between the users and local vendors using devices such as the devices 102 and 106. The server 104 receives the plumbing service request originated by the device 102 via the communication network 108. The server 104 also receives the location of the device 102 and operates to select one or more preapproved vendors from a list of preapproved vendors offering the plumbing service. The list of preapproved vendors and their locations are stored on a storage device of the server 104. In one preferred embodiment, the preapproved vendors are those vendors that have previously provided the plumbing service to other consumers and have received high-rating reviews from the consumers. The server 104 computes one or more distances between one or more vendor locations of the one or more preapproved vendors and the location of the device 102. The server 104 then selects one or more local vendors from the one or more preapproved vendors whose distances are within a predetermined region, for instance within a geographical area having the same postal zip code. The server 104 transmits one or more vendor notices via the communication network 108.

One or more local vendor devices, such as the device 106, receive the one or more vendor notices via their corresponding Apps, such as the App 110 which may be used to execute one or more of the steps of the several methods discussed herein. In one preferred embodiment, the user of the device 106, referred to as the local vendor, is notified via badges, alerts, or banners, that an urgent household-related goods or services has been requested. The user of the device 106 clicks on the App 110 and is presented with a user interface similar to the user interface of the device 102. One or more local vendors, such as the local vendor using the device 106, transmit one or more acceptances via their devices and utilizing the communication network 108.

The server 104 receives the vendor acceptances and selects one of the one or more local vendors who transmitted their acceptances to perform the plumbing service. The selection, for instance, is based on a first-come-first-serve, i.e., the server 104 selects the local vendor who accepted to perform the plumbing service first. Other criteria may be utilized to select the one local vendor such as based on performance, price range, seniority, ratings, etc. In a preferred embodiment, the server 104 may select more than just one local vendor to be presented to the consumer for selection.

The server 104 transmits a user notice including a local-vendor summary of the selected local vendor. The server 104 also transmits a local-vendor notice which includes a user summary. The device 102 receives the user notice and the device 106 receives the local-vendor notice. As stated above, the communications between the server 104, the device 102, and the device 106 is achieved using the communication network 108. In one preferred embodiment, the local-vendor summary includes at least one of name of business, type of business, phone number of business, email address of business, and address of business. In one preferred embodiment, the user summary includes at least one of name of user, phone number of user, email address of user, and address of user.

The App 110 may be further configured to include methods of providing a user interface to facilitate a visual representation of the methods of communication discussed herein. The user interface may be implemented on one or more devices such as the devices, 102, 104, and 106, separately or in combination. A user, such as the consumer or vendor discussed above, may utilize the App 110 so configured, to perform these methods. In the following and in relation to the discussion of the user interface, the term “box” is used to denote a region of the display page where the user of the interface may tap to execute one or more steps of a particular method. The box may include hyperlinks or hypertexts, depending on the embodiment being discussed.

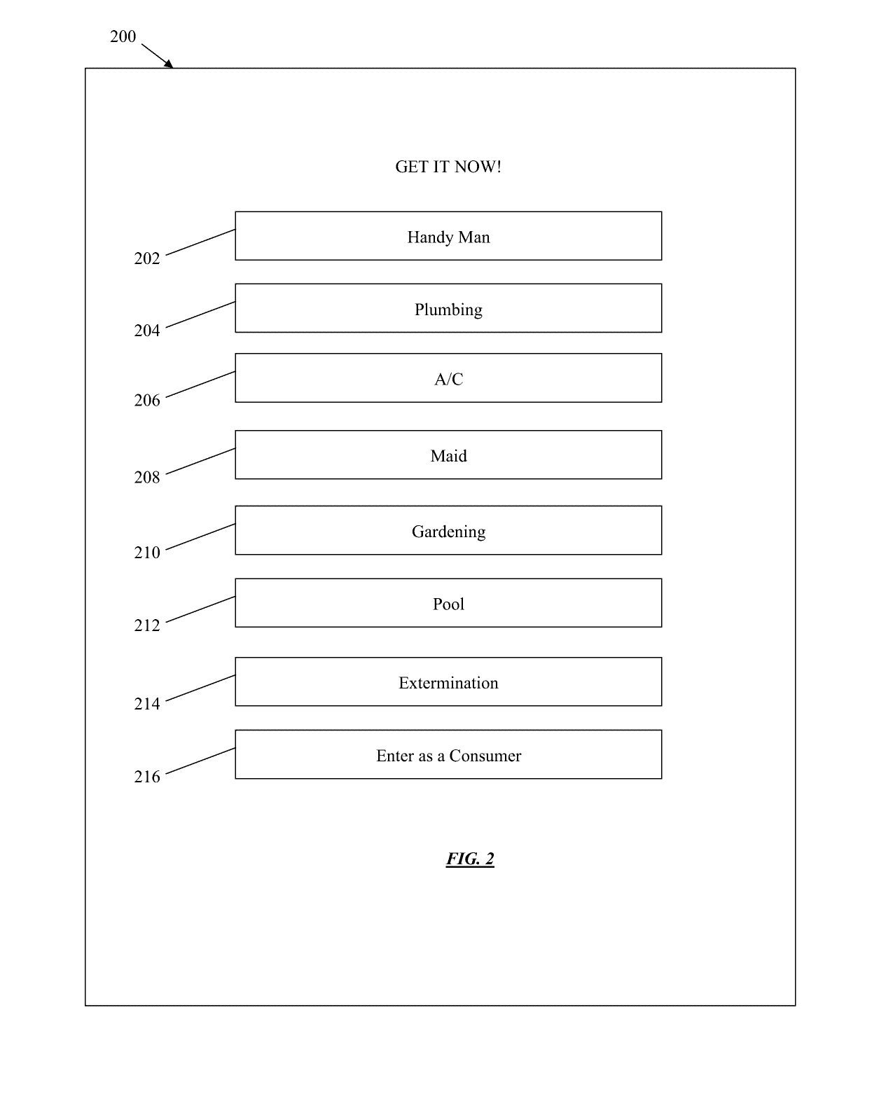

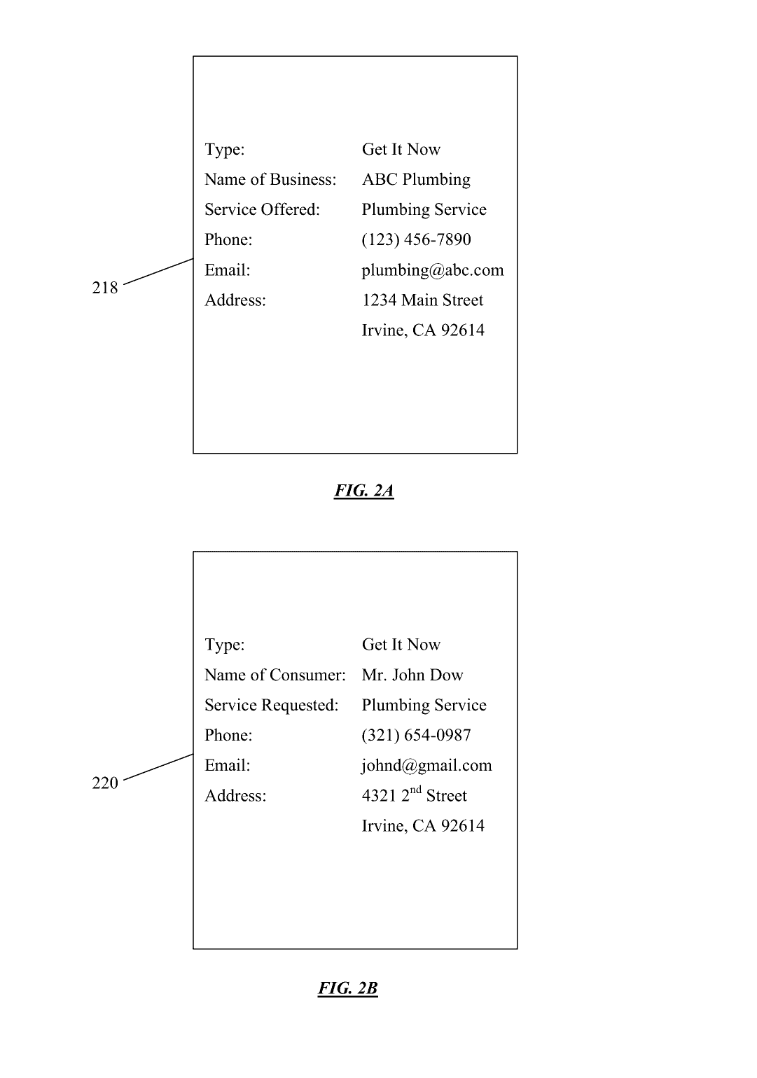

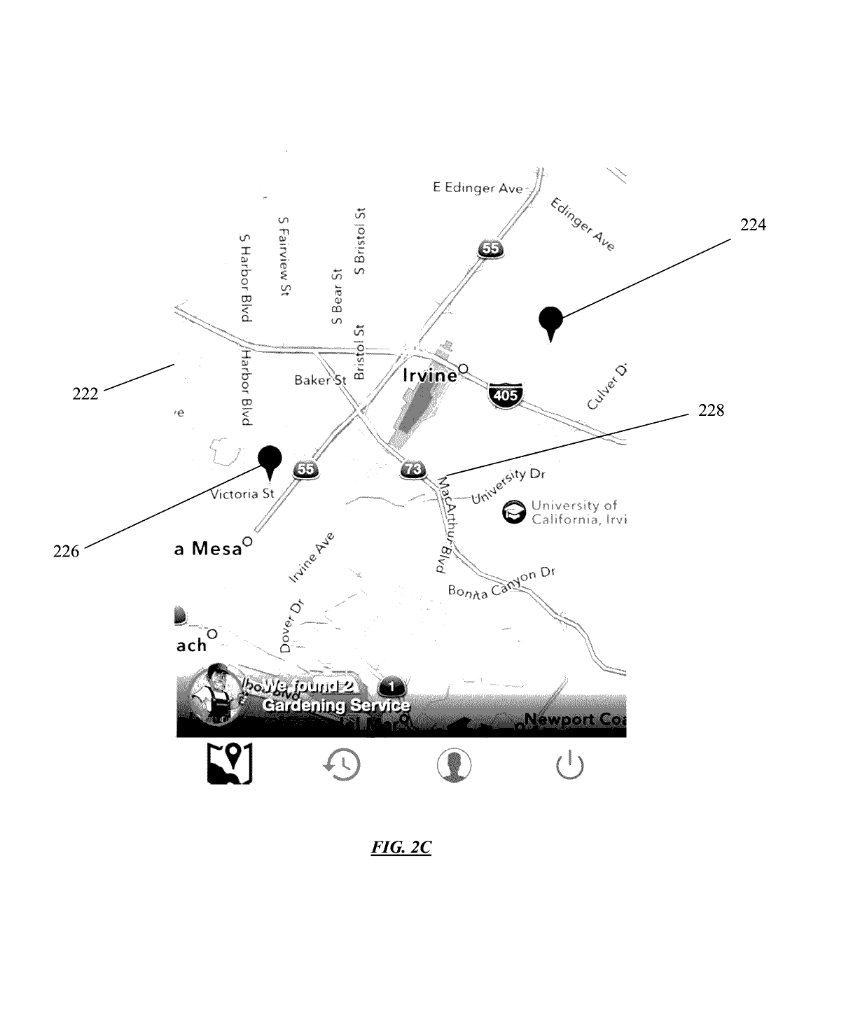

FIG. 2 depicts one preferred method of providing a user interface for obtaining urgent household-related goods or services 200 that may be implemented on a device such as the device 102 in accordance with the present invention. A box 202 shows handyman service and when tapped it will transmit a request for handyman service. The device 102 also transmits the location of the device 102 when the box 202 is tapped or otherwise activated. Boxes 204 through 214 show household-related services which the user can request. Specifically, boxes 204 through 214 show plumbing, A/C, maid, gardening, pool, and extermination services, respectively. Box 216 shows how the user interface may be utilized as a consumer or a vendor. In this preferred embodiment, the user interface has been utilized by a consumer.

The server 104 receives the request and device location and performs the above discussed steps to select one or more preapproved vendors offering plumbing services, to compute one or more distances, to select one or more local vendors from the one or more preapproved vendors whose distances are within a predetermined region, and to transmit one or more vendor notices. One or more local vendor devices, such as the device 106, receive the one or more vendor notices. Local vendors desiring to provide the requested plumbing service transmit their acceptances, utilizing a similar user interface to the one utilized by the consumer above, via their local vendor devices, such as the device 106. The server 104 selects one of the local vendors. In a preferred embodiment, the first vendor accepting to provide the requested plumbing service is selected by the server 104. In a preferred embodiment, the server 104 selects several local vendors within a predetermined region as possible candidates for the requested service.

FIG. 2A depicts one preferred method of providing a local-vendor summary in accordance with the present invention. The display of a user device, such as the device 102, displays the local-vendor summary. Upon selecting the local vendor, the server 104 transmits a user notice comprising a local-vendor summary 218 via the communication network 108. In this preferred embodiment, the local-vendor summary 218 includes the “Get It Now” type of request. In another preferred embodiment, the type of request is “Reverse Auction” which is described in more detail below. The local-vendor summary 218 further includes the name of the business, service offered, phone number, email address, and address of the local vendor. The consumer utilizing the device 102 uses the local-vendor summary to conveniently contact the local vendor offering the plumbing service. In a preferred embodiment, the above system and method is used by a consumer to obtain an urgent household-related good, such as a bottle of wine.

FIG. 2B depicts one preferred method of providing a user summary in accordance with the present invention. The display of a local vendor device, such as the device 106, displays the user summary. Upon selecting the local vendor, the server 104 transmits a local-vendor notice comprising a user summary 220 via the communication network 108. In this preferred embodiment, the user summary 220 includes the “Get It Now” type of request. In another preferred embodiment, the type of request is “Reverse Auction.” The user summary 220 further includes the name of the consumer, service requested, phone number, email address, and address of the consumer. The local vendor utilizing the device 106 uses the user summary to conveniently contact the consumer requesting the urgent household-related service or good. In this preferred embodiment, the above system and method is used by a local vendor to provide the plumbing service requested by the consumer.

FIG. 2C depicts one preferred method of providing a vendor notice 222 in accordance with the present invention. The display of a local vendor device, such as the device 106, displays the vendor notice 222. Upon selecting one or more local vendors from the one or more preapproved vendors whose distances are within a predetermined region, the server 104 transmits one or more vendor notices, such as the vendor notice 222 via the communication network 108. In this preferred embodiment, the vendor notice 222 comprises a map 228 and two green-colored balloons 224 and 226 which indicate the selected vendors. When a local vendor is selected by the server 104, for instance vendor 224, the server 104 sends another notice this time including a red-colored balloon for the vendor 226 which indicates that the user request has been accepted by the vendor 224 whose colored balloon remains green.

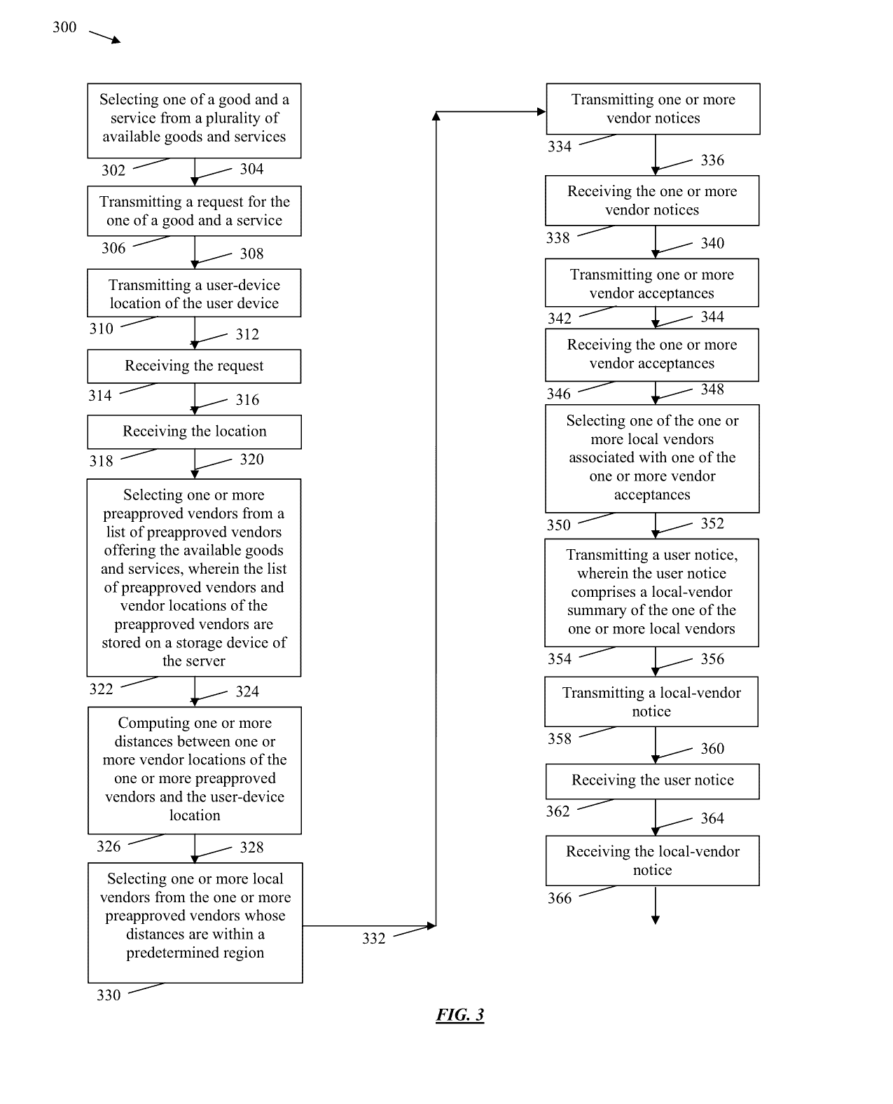

FIG. 3 shows a flow diagram 300 of one preferred method of procuring urgent household-related goods or services in accordance with the present invention which may be implemented utilizing the computer network system depicted in FIG. 1. According to this embodiment, the method comprises selecting one of a good and a service from a plurality of available goods and services, via the device 102, at 302. The method further comprises transmitting a request for the one of a good and a service, via the device 102, at 306. The method further comprises transmitting a user-device location of the user device 102, via the device 102, at 310. The method further comprises receiving the request, via the server 104, at 314. The method further comprises receiving the location of the user device 102, via the server 104, at 318. The method further comprises selecting one or more preapproved vendors from a list of preapproved vendors offering the available goods and services, wherein the list of preapproved vendors and vendor locations of the preapproved vendors are stored on a storage device of the server 104, via the server 104, at 322. The method further comprises computing one or more distances between one or more vendor locations of the one or more preapproved vendors and the user-device location, via the server 104, at 326. The method further comprises selecting one or more local vendors from the one or more preapproved vendors whose distances are within a predetermined region, via the server 104, at 330. The method further comprises transmitting one or more vendor notices, via the server 104, at 334. The method further comprises receiving the one or more vendor notices, via one or more local vendor devices, such as the device 106, at 338. The method further comprises transmitting one or more vendor acceptances, via the one or more local vendor devices, such as the device 106, at 342. The method further comprises receiving the one or more vendor acceptances, via the server 104, at 346. The method further comprises selecting one of the one or more local vendors associated with one of the one or more vendor acceptances, via the server 104, at 350. The method further comprises transmitting a user notice, wherein the user notice comprises a local-vendor summary, such as the local-vendor summary depicted in FIG. 2A, of the one of the one or more local vendors, via the server 104, at 354. The method further comprises transmitting a local-vendor notice, wherein the local-vendor notice comprises a user summary, such as the user summary depicted in FIG. 2B, via the server 104, at 358. The method further comprises receiving the user notice, via the user device 102, at 362. The method further comprises receiving the local-vendor notice, via one of the one or more local vendor devices, such as the device 106, associated with the one of the one or more local vendors at 366.

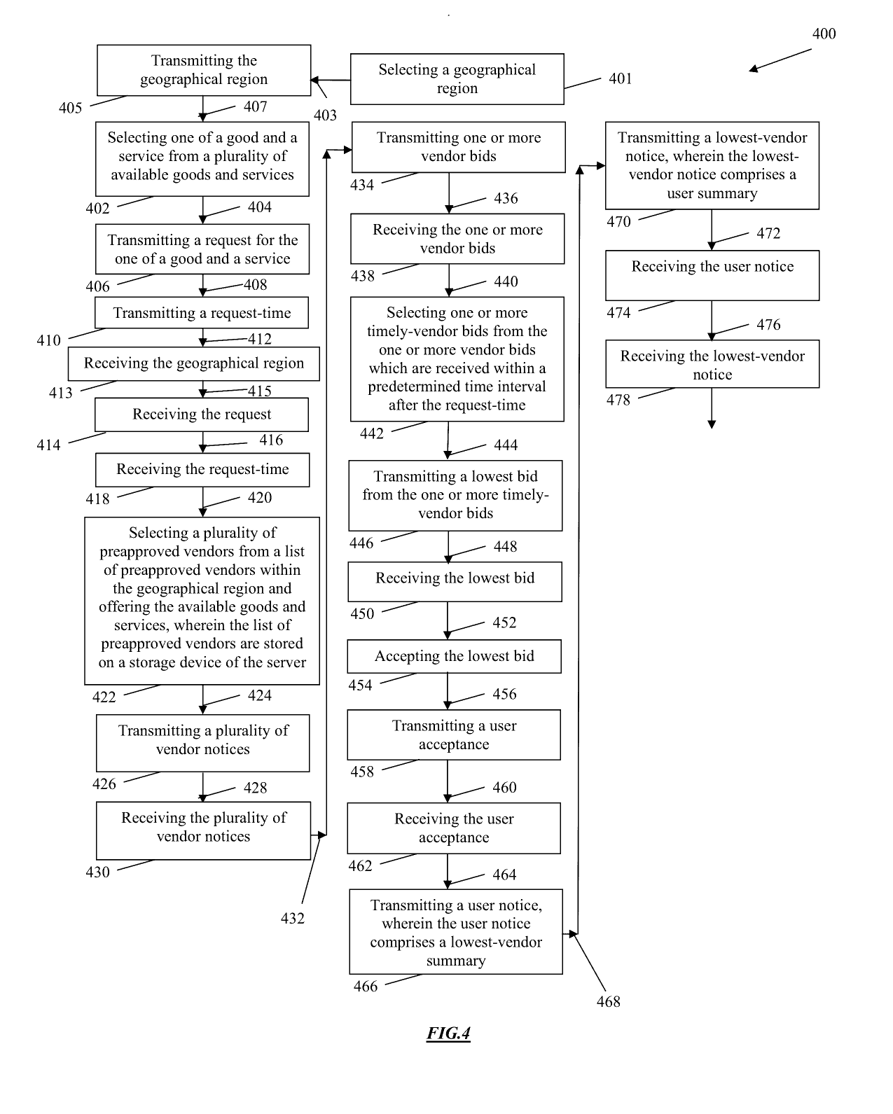

FIG. 4 shows a flow diagram 400 of one preferred method of reverse auctioning of household-related goods or services in accordance with the present invention which may be implemented utilizing the computer network system depicted in FIG. 1. According to this embodiment, the method comprises selecting a geographical region, via the device 102, at 401. The method further comprises transmitting the geographical region, via the device 102, at 405. The method further comprises selecting one of a good and a service from a plurality of available goods and services, via the device 102, at 402. The method further comprises transmitting a request for the one of a good and a service, via the device 102, at 406. The method further comprises transmitting a request-time, via the device 102, at 410. The method further comprises receiving the geographical region, via the server 104, at 413. The method further comprises receiving the request, via the server 104, at 414. The method further comprises receiving the request-time, via the server 104, at 418. The method further comprises selecting a plurality of preapproved vendors from a list of preapproved vendors within the geographical region and offering the available goods and services, wherein the list of preapproved vendors are stored on a storage device of the server 104, via the server 104, at 422. The method further comprises transmitting a plurality of vendor notices, via the server 104, at 426. The method further comprises receiving the plurality of vendor notices, via a plurality of vendor devices, such as the device 106, at 430. The method further comprises transmitting one or more vendor bids, via one or more of the plurality of vendor devices, such as the device 106, at 434. The method further comprises receiving the one or more vendor bids, via the server 104, at 438. The method further comprises selecting one or more timely-vendor bids from the one or more vendor bids which are received within a predetermined time interval after the request-time, via the server 104, at 442. The method further comprises transmitting a lowest bid from the one or more timely-vendor bids, via the server 104, at 446. The method further comprises receiving the lowest bid, via the user device 102, at 450. The method further comprises accepting the lowest bid, via the user device 102, at 454. The method further comprises transmitting a user acceptance, via the user device 102, at 458. The method further comprises receiving the user acceptance, via the server 104, at 462. The method further comprises transmitting a user notice, wherein the user notice comprises a lowest-vendor summary, similar to the local-vendor summary depicted in FIG. 2A, via the server 104, at 466. The method further comprises transmitting a lowest-vendor notice, wherein the lowest-vendor notice comprises a user summary, similar to the user summary depicted in FIG. 2B, via the server 104, at 470. The method further comprises receiving the user notice, via the device 102, at 474. The method further comprises receiving the lowest-vendor notice, via one of the one or more of the plurality of vendor devices, such as the device 106, associated with the lowest bid at 478.

The foregoing discloses methods, mediums, and computer network systems for procuring spatially feasible on-demand household-related goods or services. Methods also include reverse auctioning of household-related goods or services. Methods of the present invention including the user interface may be implemented on devices such as smart phones, desktop computers, and servers. It provides consumers and vendors with a platform where they can request and obtain goods or services.

The described embodiments can also be embodied as computer readable code on a non-transitory computer readable medium. A non-transitory computer readable medium is any data storage device that can store data which can thereafter be read by a computer system, other than medium designed specifically for propagating transitory signals. Examples of non-transitory computer readable media include floppy disks, flash memory devices, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions. In various embodiments, software-instructions stored on a machine-readable storage medium can be used in combination with hardwired circuitry to implement the present invention. Thus, the techniques are not limited to any specific combination of hardware circuitry and software instructions, or to any particular source for the instructions executed by the data processing system associated with an apparatus for performing one or more of the operations described herein.

User interface comprises components that interact with a user to receive user inputs and to present media and/or information. User interface may include a speaker, microphone, buttons, lights, display screen, touch screen, touch pad, scroll wheel, communication port, or some other user input/output apparatus including combinations thereof.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A machine implemented method of procuring urgent household-related goods or services, comprising:
(i) selecting one of a good and a service from a plurality of available goods and services, via a user device;
(ii) transmitting a request for the one of a good and a service, via the user device;
(iii) transmitting a user-device location of the user device, via the user device;
(iv) receiving the request, via a server;
(v) receiving the location, via the server;
(vi) selecting one or more preapproved vendors from a list of preapproved vendors offering the available goods and services, wherein the list of preapproved vendors and vendor locations of the preapproved vendors are stored on a storage device of the server, via the server;
(vii) computing one or more distances between one or more vendor locations of the one or more preapproved vendors and the user-device location, via the server;
(viii) selecting one or more local vendors from the one or more preapproved vendors whose distances are within a predetermined region, via the server;
(ix) transmitting one or more vendor notices, via the server;
(x) receiving the one or more vendor notices, via one or more local vendor devices;
(xi) transmitting one or more vendor acceptances, via the one or more local vendor devices;
(xii) receiving the one or more vendor acceptances, via the server;
(xiii) selecting one of the one or more local vendors associated with one of the one or more vendor acceptances, via the server;
(xiv) transmitting a user notice, wherein the user notice comprises a local-vendor summary of the one of the one or more local vendors, via the server;
(xv) transmitting a local-vendor notice, wherein the local-vendor notice comprises a user summary, via the server;
(xvi) receiving the user notice, via the user device; and
(xvii) receiving the local-vendor notice, via one of the one or more local vendor devices associated with the one of the one or more local vendors.

2. The method of claim 1, wherein the local-vendor summary comprises at least one of name of business, type of business, phone number of business, and address of business.

3. The method of claim 1, wherein the user summary comprises at least one of name of user, phone number of user, and address of user.

4. The method of claim 1, further comprising transmitting one or more local-vendor rejection notice, via the server.

5. A machine implemented method of obtaining urgent household-related goods or services, comprising:
(i) selecting one of a good and a service from a plurality of available goods and services, via a user device;
(ii) transmitting a request for the one of a good and a service, via the user device;
(iii) transmitting a user-device location of the user device, via the user device; and
(iv) receiving a user notice, via the user device;
wherein the user notice comprises local-vendor summary of a local vendor, wherein the local vendor is selected from one or more local vendors, wherein the one or more local vendors are selected from one or more preapproved vendors whose distances between their locations and user-device location are within a predetermined region, and wherein the one or more preapproved vendors are selected from a list of preapproved vendors offering the available goods and services.

6. The method of claim 5, wherein the predetermined region is a geographical area having the same postal zip code.

7. The method of claim 5, wherein the one of a good and a service from a plurality of available goods and services is one of a pizza, bottle of wine, a cigar, a handyman service, a plumbing service, a maid service, and a gardening service.

8. A non-transitory machine-readable storage medium, which provides instructions that, when executed by a processing system, causes the processing system to perform operations according to a method as in claim 5.

9. A method of providing a user interface for obtaining urgent household-related goods or services, the user interface being accessible via the user device, said method comprising a method as in claim 5.

10. A non-transitory machine-readable storage medium, which provides instructions that, when executed by a processing system, causes the processing system to perform operations according to a method as in claim 9.

11. A computer network system for procuring urgent household-related goods or services, comprising:
(a) a user device having a processing unit and program code stored on a storage device of said user device, said program code to perform a user method when executed by said processing unit;
(b) a server having a processing unit and program code stored on a storage device of said server, said program code to perform a server method when executed by said processing unit; and
(c) one or more local vendor devices, each local vendor device having a processing unit and program code stored on a storage device of said local vendor device, said program code to perform a local vendor method when executed by said processing unit;
said user method, comprising:
(i) selecting one of a good and a service from a plurality of available goods and services;
(ii) transmitting a request for the one of a good and a service;
(iii) transmitting a user-device location of the user device; and
(iv) receiving a user notice;
said server method, comprising:
(i) receiving the request;
(ii) receiving the location;
(iii) selecting one or more preapproved vendors from a list of preapproved vendors offering the available goods and services, wherein the list of preapproved vendors and vendor locations of the preapproved vendors are stored on the storage device of the server;
(iv) computing one or more distances between one or more vendor locations of the one or more preapproved vendors and the user-device location;
(v) selecting one or more local vendors from the one or more preapproved vendors whose distances are within a predetermined region;
(vi) transmitting one or more vendor notices;
(vii) receiving one or more vendor acceptances;
(viii) selecting one of the one or more local vendors associated with one of the one or more vendor acceptances;
(ix) transmitting the user notice, wherein the user notice comprises a local-vendor summary of the one of the one or more local vendors; and
(x) transmitting a local-vendor notice, wherein the local-vendor notice comprises a user summary;
said local vendor method, comprising:
(i) receiving the one or more vendor notices;
(ii) transmitting the one or more vendor acceptances; and
(iii) receiving the local-vendor notice, via one of the one or more local vendor devices associated with the one of the one or more local vendors.

12. The system of claim 11, wherein the local-vendor summary comprises at least one of name of business, type of business, phone number of business, and address of business.

13. The system of claim 11, wherein the user summary comprises at least one of name of user, phone number of user, and address of user.

14. The system of claim 11, wherein the predetermined region is a geographical area haying the same postal zip code.

15. The system of claim 11, wherein the one of a good and a service from a plurality of available goods and services is one of a pizza, bottle of wine, a cigar, a handyman service, a plumbing service, a maid service, and a gardening service.

16. A machine implemented method of reverse auctioning of household-related goods or services, comprising:
(i) selecting a geographical region, via a user device;
(ii) transmitting the geographical region, via the user device;
(iii) selecting one of a good and a service from a plurality of available goods and services, via the user device;
(iv) transmitting a request for the one of a good and a service, via the user device;
(v) transmitting a request-time, via the user device;
(vi) receiving the geographical region, via a server;
(vii) receiving the request, via the server;
(viii) receiving the request-time, via the server;
(ix) selecting a plurality of preapproved vendors from a list of preapproved vendors within the geographical region and offering the available goods and services, wherein the list of preapproved vendors are stored on a storage device of the server, via the server;
(x) transmitting a plurality of vendor notices, via the server;
(xi) receiving the plurality of vendor notices, via a plurality of vendor devices;
(xii) transmitting one or more vendor bids, via one or more of the plurality of vendor devices;
(xiii) receiving the one or more vendor bids, via the server;
(xiv) selecting one or more timely-vendor bids from the one or more vendor bids which are received within a predetermined time interval after the request-time, via the server;
(xv) transmitting a lowest bid from the one or more timely-vendor bids, via the server;
(xvi) receiving the lowest bid, via the user device;
(xvii) accepting the lowest bid, via the user device;
(xviii) transmitting a user acceptance, via the user device;
(xix) receiving the user acceptance, via the server;
(xx) transmitting a user notice, wherein the user notice comprises a lowest-vendor summary, via the server;
(xxi) transmitting a lowest-vendor notice, wherein the lowest-vendor notice comprises a user summary, via the server;
(xxii) receiving the user notice, via the user device; and
(xxiii) receiving the lowest-vendor notice, via one of the one or more of the plurality of vendor devices associated with the lowest bid.

17. The method of claim 16, wherein the predetermined time interval is three days.

18. The method of claim 16, wherein the one of a good and a service from a plurality of available goods and services is one of a pizza, bottle of wine, a cigar, a handyman service, a plumbing service, a maid service, and a gardening service.

19. A non-transitory machine-readable storage medium, which provides instructions that, when executed by a processing system, causes the processing system to perform operations according to a method as in claim 16.

20. A method of providing a user interface for obtaining urgent household-related goods or services, the user interface being accessible via the user device, the plurality of vendor devices, and the server, said method comprising a method as in claim 16.

21. A non-transitory machine-readable storage medium, which provides instructions that, when executed by a processing system, causes the processing system to perform operations according to a method as in claim 20.
